(19) United States
(12) Patent Application Publication
(10) Pub. No.: US 2012/0133517 A1
(43) Pub. Date: May 31, 2012

(54) Alarm Apparatus

(75) Inventors: Thomas Brausteiner, Wien (AT); Bernhard Haverkamp, Ascheberg (DE)

(73) Assignee: Katoram Safety Solutions AG, Zug (CH)

(21) Appl. No.: 12/226,538

(22) PCT Filed: Apr. 12, 2007
(86) PCT No.: PCT/AT2007/000163

§ 371 Date: Aug. 21, 2009

(30) Foreign Application Priority Data
Apr. 21, 2006 (AT) A 685/2006

(51) Int. Cl. G08B 21/00

(52) U.S. Cl. 340/626

(57) ABSTRACT

Disclosed is a portable alarm apparatus (10) comprising an adhesive suction mechanism (12), a device (3) for monitoring the suction pressure, a device for generating a negative pressure (2), which is connected to the adhesive suction mechanism (12) and maintains the negative pressure in the adhesive suction mechanism (12) substantially constant at a preset value, and an alarm control device (21) that generates an alarm signal when the suction pressure falls below a predetermined threshold value when the preset negative pressure can no longer be maintained.

This invention relates to a transportable alarm device, especially an alarm device for post-installation suitable for protecting areas to be surveyed.

Reference to alarm devices for airplanes and airport buildings in the present application does not limit the scope of the invention but is intended as an exemplary representation. The field of application of the inventive alarm device rather comprises any area to be surveyed, which may be stationary or movable, e.g. in vehicles.

Despite the variety of alarm devices already available, certain requirements explained in detail below have not been met so far.

U.S. Pat. No. 5,489,890, for example, describes a portable alarm device having a housing attachable to an appropriate surface by means of a suction cup and having a contact in the interior, which is actuatable via a flexible line coupled to another suction cup, which may, for example, be sucked to a door. The housing of the alarm device is attached to a surface by means of a suction element, however, this happens in a completely unpredictable way with different surface structures. The adhesiveness of the simple suction cups used is not controllable, and these may easily be detached, so that this device has only minor reliability. Furthermore, the flexible line for triggering the alarm by establishing contact when the tab attached to the end of the flexible line is removed also constitutes a rather unreliable measure, which is failure-prone and may be disturbed from the exterior by cutting the line.

DE 91 10 342 A sets forth a device for protecting objects, wherein a pressure sensor formed as a suction element is attachable to the object to be protected, and the pressure sensor triggers an alarm dependent on the interior pressure within the suction element when said pressure exceeds a certain value. The suction element is attached by pressing it to the surface of the object to be protected. Contrary to the invention, the alarm device is not present on the object itself but stationary and connected to the pressure sensor via a cable. This cable may be cut by unauthorized persons. A further disadvantage regards the attachment of the suction element to the object, which depends on environmental influences and the type of surface of the object and may thus vary, which may result in the detachment of the suction element from the surface.

In the pneumatic attachment device according to U.S. Pat. No. 3,840,870 A, the increased pressure within a suction element during contact with an object or a surface is also converted into an alarm signal. This operating principle is not based on monitoring the negative pressure of the suction cup, as is the case in the present invention, so that for surveying doors a special mechanism is required in order to achieve the generation of a signal. Since such constructional measures should be avoided on doors or on areas to be protected, such a device is not suitable for solving the task of the invention.

In some applications, an area has to be protected where no constructional measures have been taken to prevent intrusion into this area, either because this has not been considered during construction or because there are binding provisions prohibiting such locking devices. The latter is, for example, the case with airplanes, where because of safety reasons, no locking devices prone to failure are allowed for cabin or entrance doors. This results in a problem regarding the surveillance of airplanes parking on airfields. Conventional seals are often opened improperly by ground staff, which makes it impossible to determine whether the respective airplane has been entered by unauthorized persons. However, this security problem is also found in other fields, so that the present invention is not limited to protecting airplanes.

First inventive considerations have been sparked by security gaps found on airfields and in airport buildings.

According to an international agreement, airplanes must not have any locking devices that could represent an insuperable obstacle for passengers or be prone to failure in the case of emergency. Consequently, an airplane must always be openable from the interior or the exterior without any key or other locking device. The installation of other door surveillance measures is also a very restricted because malfunctioning could affect full operatability of an airplane boarding door.

This regulation leads to problems in protecting airplanes on airfields, as, due to the situation described, any person may enter and exit a parked airplane without any possibility of control.

Thus, the object of the invention is to provide a transportable alarm device,
which permits reliable reporting on intrusion into an area to be protected,
which can be quickly attached and detachable, irrespective of e.g. the design of a door,
which can be operated without any external energy source,
which can perform its protecting function reliably for a longer period,
the function of which may virtually not be interrupted by unauthorized persons,
which does not require any constructional modifications, as for example the provision of a locking mechanism on a door to be protected.

A further task of the invention is to provide an alarm device of the type mentioned at the beginning, which may, irrespective of structural and constructional circumstances, be easily attached and be removed at any time, and which also allows temporary protection of an area without the necessity of providing locking or latching means that might pose a danger to safety.

According to the invention, the transportable alarm device comprises the following:
an adhesive suction device, by means of which the transportable alarm device is attachable to a surface of an area to be surveyed,
a device for monitoring the suction negative pressure, which is connected to the adhesive suction device,
a device for generating a negative pressure, which is connected to the adhesive suction device and which maintains the negative pressure in the adhesive suction device, when in an attached state, essentially constant at a preset value,
an alarm control device, which is connected to a signal output of the device for monitoring the suction negative pressure, wherein the alarm control device generates an alarm signal in case the suction negative pressure decreases below a predeterminable threshold value, when the preset negative pressure cannot be maintained anymore.

By means of the adhesive suction device, the inventive alarm device can be temporarily attached to any appropriate surface and be detached as required. Unauthorized intrusion into the area to be protected is detected and reported, when the suction negative pressure in the adhesive suction device decreases below a certain range limit. When the alarm device is not needed anymore, it can at any time be detached from the surface to which it is attached by suction. Parked airplanes may thus be protected against intrusion without the necessity of making constructional modifications at the doors of the airplanes. These doors are subject to special safety regulations prohibiting latching or electronic locking and monitoring devices. Thus, use of the inventive alarm device for this sensible field is especially effective.

By means of the negative pressure generating device, secure and permanent attachment of the inventive alarm device during surveillance operation can be guaranteed.

Furthermore, the device for monitoring the suction negative pressure in the adhesive suction device is connected to the adhesive suction device, preferably via pressure lines. The pressure within the pressure lines is constantly measured by a measuring device provided for this purpose. When the negative pressure decreases strongly, for example when the pressure within the lines approximates ambient pressure, because the adhesive suction device has been detached from the attachment surface, the alarm signal is triggered.

Furthermore, the preferably electrical signal output of the device for monitoring the suction negative pressure is connected to the alarm control device, which again may be connected to at least one alarm device, e.g. a GSM unit, a video camera, a sound generation unit, a storage unit and the like. All conventional and known alarm signals and control means may be provided in order to detect and report intrusion into the area to be protected, either for recording these activities or for initiating defensive measures by security personnel.

The inventive device may be attached to the outer shell of the parked airplane and be activated at any time in order to report opening of the boarding doors. But the invention is also usable for protecting other security zones, such as in airport buildings. In such buildings there is an unobservable number of doors, which for economic reasons cannot all be fitted with locking or security mechanisms. The inventive device may consequently be attached and used temporarily for certain applications. Such a device thus constantly meets changing surveillance requirements for several doors.

An important aspect of the invention consists in the independence of the inventive alarm device from constructional circumstances of the area to be protected. According to one embodiment of the invention, the device for monitoring the suction negative pressure and the device for generating a negative pressure may be accommodated within the interior of a housing, the adhesive suction device being attached to the exterior of the housing. The components contained within the housing are thus protected from external influences, and by means of the adhesive suction device the housing may be attached to the surface of the area to be protected in the form of a ready-made unit.

Furthermore, there may be provided an energy-supply unit in the interior of the housing, which unit may, for example, be a rechargeable battery. However, instead of the rechargeable battery, other energy sources known to persons skilled in the art and guaranteeing independent supply may also be used, e.g. solar cells or fuel cells and the like.

The adhesive suction device may be formed of one or more adhesive suction means with adhesive suction faces for adhering to surfaces. Such known adhesive suction means, which may, for example, be formed of rubber and the like, allow the inventive alarm device to be strongly adhered to, for example, the exterior surface of an airplane, preferably to the exterior wall of the door and the adjacent exterior wall area of the airplane fuselage, in order to detect opening of the door. During the opening process, the inventive alarm device is detached and may fall to the ground below. It is so solidly built, that this impact effect does not affect its functioning. Of course, the inventive alarm device may also be attached to the interior of an airplane or another area to be protected.

In the case of airplane boarding doors, these form an almost plane surface with the surrounding area. For such an application is has proven advantageous to form the adhesive suction device of two or more adhesive suction means that are arranged spaced from each other on an external surface of the housing, their adhesion faces being flush with a plane parallel to the external surface. Thus, in an attached state, the housing holding the components of the inventive alarm device is arranged parallel above an area enclosing the door gap.

Simple doors, on the other hand, comprise a door frame and a door leaf, which in a closed state comes to rest at a right angle to the door frame interior surface. In order to avoid any problems during attachment of the inventive alarm device in this case, the adhesive suction device may be formed of two or more adhesive suction means that are arranged on two exterior surfaces of the housing perpendicular to each other. One exterior surface may be attached parallel to the door leaf, the other exterior surface parallel to the door frame interior surface.

For achieving a permanent adhesive effect, the one or more adhesive suction means may have through channels, one end of which terminates in the adhesive suction face and the other end of which is connected to the device for generating a negative pressure. The negative pressure at the adhesive suction face may, however, also be provided by different structures. When the device is detached from the surface to which it adheres, the alarm is triggered.

The device for generating a negative pressure may be an evacuating pump, e.g. a vacuum pump.

One aspect of the invention thus concerns the use of the inventive transportable alarm device for attachment to a door area to be surveyed.

Especially with the transport of valuables, there is often the problem that these can be watched only insufficiently. During the transport of money, for example, there are repeatedly security gaps because responsible guards are often negligent and leave vehicle doors open, so that containers with valuable objects or money bags can be stolen. In order to prevent such removal from e.g. a vehicle, it may be provided that the housing of the inventive alarm device comprises a container for safekeeping objects to be protected. The complete alarm device may then be attached to the interior surface of a vehicle and/or to other objects or houses of alarm devices, so that removal is only possible by detaching the alarm device together with the container from the wall and/or another housing. This event may be reported by the alarm device to a control center, which will immediately send security personnel to the scene of action.

Furthermore, the container accommodated within the housing may be lockable, and a negative pressure may be maintained therein, which negative pressure is monitorable by means of a negative pressure monitoring unit, so that an alarm signal is generated when the container is opened without authorization and consequently ambient pressure is reached in the container. Thus, it may also be monitored at what point the container is opened by force. This is important in those cases in which thieves take the stolen container to another place to break it open. Via GPS locating, this process may be located.

A further task of the invention is to set forth an alarm device, which enables protection against removal of valuable objects from an area to be surveyed.

This is achieved by use of an inventive transportable alarm device for attachment to a transport container, e.g. a cargo container or a transport vehicle, e.g. a money transporter.

Below, the invention is described in detail by embodiments illustrated in the drawings. Therein,

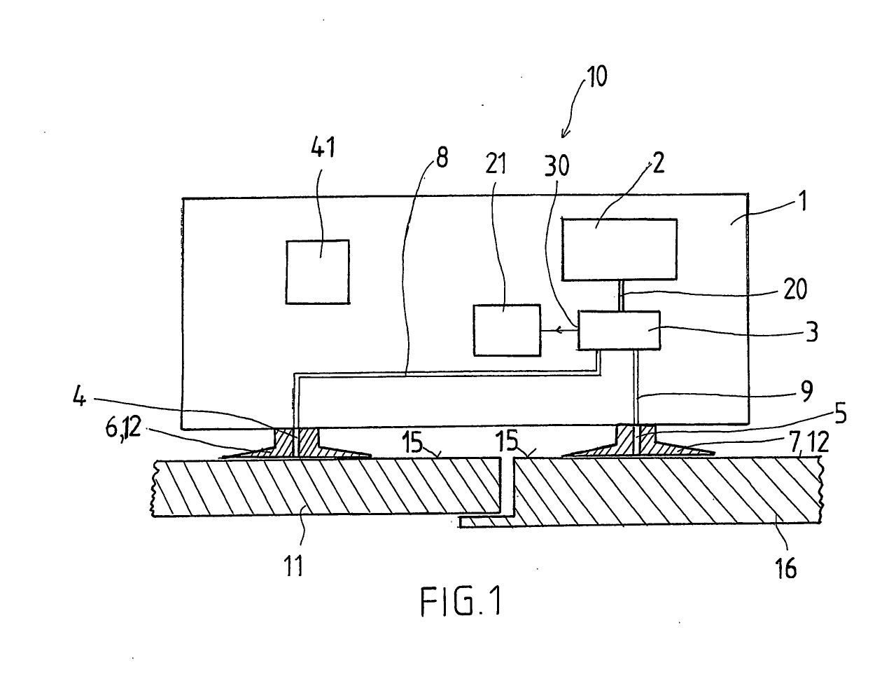

FIG. 1 is a schematic representation of an embodiment of the inventive transportable alarm device;

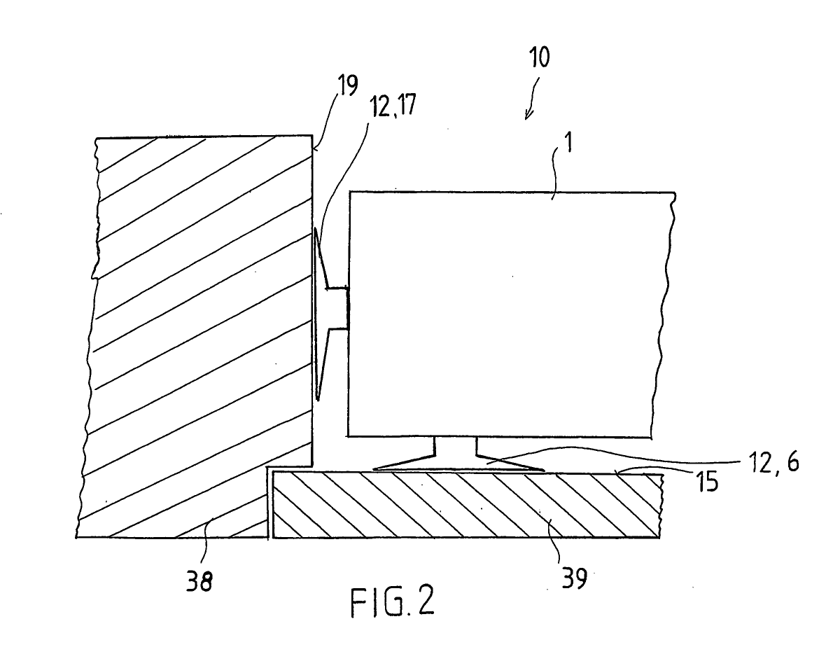

FIG. 2 is a schematic representation of a further embodiment of the inventive transportable alarm device; and

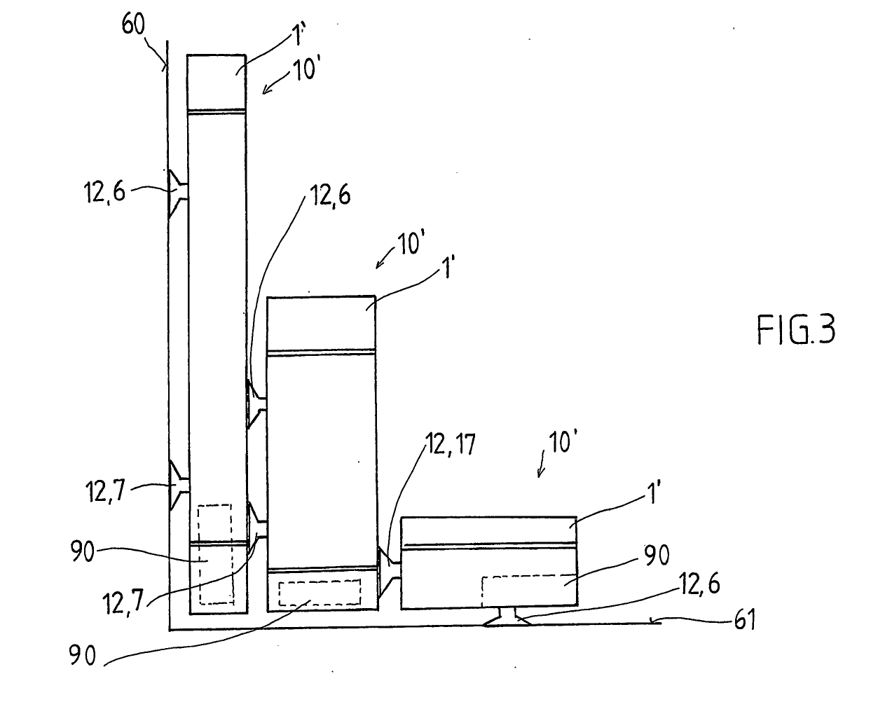

FIG. 3 is a schematic representation of a further embodiment of the inventive transportable alarm device.

A transportable alarm device 10 is formed for protecting an area against intrusion and is preferably operated by an independent energy supply unit, e.g. a rechargeable battery 41 or storage battery, in a mains-independent fashion. In a larger scale of application, several alarm devices 10 may be interconnected to provide a network, e.g. in a master-slave operation.

The area to be protected may, without limiting the scope of the invention, be an airplane on an airfield or a certain area within an airport building. The alarm device 10 is designated transportable because it is at any time attachable and detachable at the area to be protected without any constructional measures.

According to the invention, an adhesive suction device 12 is provided, by means of which the alarm device 10, parts of which are accommodated within a housing 1, is attachable to a surface 15 of an area boundary. This area boundary may, for example, be formed by an exterior wall 11 of an airplane and a door leaf 16 for closing an access hatch.

In the exemplary embodiment according to FIG. 1, an adhesive suction device 12 is formed of two rubber adhesive suction means 6, 7 each having an adhesive suction face for adherence to a surface 15, which means are arranged spaced from each other, wherein their adhesive suction faces are arranged flush with a plane parallel to the external surface, so that a housing 1 may be attached to the surface 15 in a parallely spaced relation.

Furthermore, only one or several suction means may be provided. The suction means 6, 7 may, in an embodiment not shown, also be connected to the alarm device via hinges.

By means of the rubber adhesive suction means 6, 7, the housing 1 of the alarm device 10 is attached to the surface 15, e.g. the outer shell of an airplane, of the area boundary and maintained there.

Furthermore, according to the invention there is provided a device 3 for monitoring the suction negative pressure in the adhesive suction device 12, which is connected to the adhesive suction device 12 via pressure lines 8, 9. When the negative pressure decreases below a predeterminable threshold value, an alarm signal is generated.

In order to be able to monitor the suction pressure, the adhesive suction means 6, 7 are each provided with a through channel 4, 5, one end of which terminates in the adhesive suction face and the other end of which is, on the one hand, connected to the device 3 for monitoring the negative pressure, and on the other hand, via that, to a device for generating a negative pressure 2, which maintains the negative pressure in the adhesive suction device 12, when in an attached state, essentially constant at a preset value. The negative pressure is monitored within the lines 8, 9 by means of a pressure measuring device in the device 3, and when the negative pressure decreases below a predeterminable threshold value, e.g. 90% of normal negative pressure, an alarm signal is generated by an alarm control device 21 at a preferably electrical signal output 30 of the device 3. The device for generating a negative pressure 2 may, for example, be an evacuating pump, e.g. a vacuum pump.

The electrical signal output 30 of the device 3 for monitoring the suction negative pressure is connected to the alarm control device 21 generating the alarm signal, which again is connected to at least one alarm device, e.g. a GSM unit, a video camera, a sound generation unit, a storage unit and the like. Thus, any type of alarm may be generated, e.g. an emergency or alert call via a telephone connection, putting into operation a video camera recording the intruder, or simply a sound signal acoustically alerting security personnel.

At the same time, the alarm control device may also contain a GPS locating unit, which allows the inventive alarm device 10 to be located rather accurately, if this is required for the respective application.

When the inventive alarm device 10 is brought into service, it is attached by means of the adhesive suction means 6, 7 so as to cover the closing area of a door at the area boundary, as shown in FIG. 1. In order to reliably guarantee adhesion, the vacuum pump 2 constantly sets the negative pressure to a predetermined value by aid of a controlling means. Thus, permanent attachment of the inventive alarm device 10 to the surface 15 is established.

When the door leaf 16 is opened by an intruder, at least one adhesion surface of the adhesive suction means 6, 7 is detached from the surface so far that the threshold value is not maintained, the vacuum pump 2 cannot keep up the predetermined negative pressure anymore, and the device 3 detects that the pressure has fallen below the threshold value, which results in the generation of an alarm signal at the output 30. In this way, any alert and alarm device may be triggered via the alarm control device 21.

FIG. 2 shows a further exemplary embodiment of the inventive alarm device 10, which facilitates attachment to single-wing doors. As shown in FIG. 2, in such cases a door leaf 39 in the closed state sits tightly against a door frame 38, so that on one side the door leaf 39 and the door frame 38 do not have a flush course, but there is a receding surface area. Therefore, the adhesive suction device 12 is in this case formed of two adhesive suction means 6, 17 that are arranged on two external surfaces of the housing 1 perpendicular to each other, which facilitates attachment of the inventive alarm device 10. The interior setup of the alarm device 10 is the same as in FIG. 1, with the adhesive suction means 7 in FIG. 1 being replaced by a second adhesive suction means 17 in FIG. 2.

The adhesive suction means 6 on one surface of the housing 1 thus adheres to surface 15 of the door leaf 39, and the adhesive suction means 17 on housing 1 adheres to surface 19 of the door frame 38. When the door leaf 39 is opened, the adhesive suction means 6 and/or the adhesive suction means 17 is/are detached from the surface to which they adhere, which results in the alarm device 21 generating an alarm signal.

The embodiments of FIG. 1 and FIG. 2 thus show the use of an inventive alarm device for attachment to a door area to be surveyed. A further possible use of the inventive transportable alarm device consists in attachment within a transport container, e.g. a cargo container or a transport vehicle, e.g. a money transporter. Stationary application is also possible, e.g. in a bank safe.

In this regard, FIG. 3 shows an embodiment of the inventive alarm device 10′, wherein each housing 1′ has a container 90 for safekeeping objects to be protected, e.g. valuable art objects, cash, jewelry, securities and the like. Overall, FIG. 3 shows three exemplary alarm devices 10′ with housings 1′ of different sizes, which are attached in the interior of e.g. a money transporter to walls 60, 61 and/or a respectively adjacent alarm device 10′. The attachment to each other or to the walls 60, 61 may be varied according to the number and type of housings 1′ present. Detachment of one or more of the housings 1′ gives rise to an alarm signal, which reports removal or gives a perceptible alarm.

For further security, the container accommodated within the housing may be lockable, and a negative pressure may be maintained therein during e.g. transport, which negative pressure may be monitored by means of a negative pressure monitoring unit not shown, so that an alarm signal is generated when the container is opened without authorization and consequently ambient pressure is reached in the container. Since the inventive alarm device already comprises all units required therefor, these may be used for said purpose as well.

1. Transportable alarm device (10, 10′), comprising the following:
an adhesive suction device (12), by means of which the transportable alarm device (10, 10′) is attachable to a surface (15, 19, 60, 61) of an area to be surveyed,
a device (3) for monitoring the suction negative pressure, which is connected to the adhesive suction device,
a device for generating a negative pressure (2), which is connected to the adhesive suction device (12) and which maintains the negative pressure in the adhesive suction device (12), when in an attached state, essentially constant at a preset value,
an alarm control device (21), which is connected to a signal output (30) of the device (3) for monitoring the suction negative pressure, wherein the alarm control device (21) generates an alarm signal in case the suction negative pressure decreases below a predeterminable threshold value, when the preset negative pressure cannot be maintained anymore.

2. Transportable alarm device of claim 1, characterized in that the device (3) for monitoring the suction negative pressure and the device for generating a negative pressure (2) are accommodated within the interior of a housing (1, 1′) and that the adhesive suction device (12) is attached to the exterior of the housing (1, 1′).

3. Transportable alarm device of claim 2, characterized in that an energy-supply unit is provided in the interior of the housing (1, 1′).

4. Transportable alarm device of claim 3, characterized in that the energy-supply unit is a rechargeable battery (41).

5. Transportable alarm device of one of the claims 1 to 4, characterized in that the adhesive suction device (12) is formed of one or more adhesive suction means (6, 7, 17) with adhesive suction faces for adhering to the surface (15, 19, 60, 61) of the area to be surveyed.

6. Transportable alarm device of claim 5, characterized in that the adhesive suction device (12) is formed of two or more adhesive suction means (6, 7) that are arranged spaced from each other on an external surface of the housing (1), their adhesion faces being flush with a plane parallel to the external surface.

7. Transportable alarm device of claim 5, characterized in that the adhesive suction device (12) is formed of two or more adhesive suction means (6, 17) that are arranged on two exterior surfaces of the housing (1) perpendicular to each other.

8. Transportable alarm device of claim 5, 6 or 7, characterized in that the adhesive suction means (6, 7, 17) is/are formed of rubber.

9. Transportable alarm device of one of the claims 5 to 8, characterized in that the adhesive suction means (6, 7, 17) has/have a through channel (4, 5), one end of which terminates in the adhesive suction face and the other end of which is connected to the device for generating a negative pressure (2).

10. Transportable alarm device of one of the preceding claims, characterized in that the device for generating a negative pressure (2) is a vacuum pump.

11. Transportable alarm device of one of the preceding claims, characterized in that the device (3) for monitoring the suction negative pressure in the adhesive suction device is connected to the adhesive suction device (12) via pressure lines (8, 9).

12. Transportable alarm device of one of the preceding claims, characterized in that the alarm control device (21) is connected to at least one alarm device, e.g. a GSM unit, a video camera, a sound generation unit, a storage unit and the like.

13. Transportable alarm device of one of the preceding claims, characterized in that the device for generating a negative pressure (2) is, via a pressure line (20), connected to the device (3) for monitoring the negative pressure and, via that, to the adhesive suction device (12).

14. Transportable alarm device of one of the preceding claims, characterized in that the housing (1′) has a container (90) for safekeeping objects to be protected.

15. Transportable alarm device of claim 14, characterized in that the container (90) accommodated within the housing (1′) is lockable, and that a negative pressure may be maintained therein, which negative pressure may be monitored by means of a negative pressure monitoring unit, so that an alarm signal is generated when the container (90) is opened without authorization and consequently ambient pressure is reached in the container (90).

16. Use of a transportable alarm device (10) of one of the preceding claims 1 to 13 for attachment to a door area to be surveyed.

17. Use of a transportable alarm device (10′) of one of the preceding claims 1 to 15 for attachment to a transport container to be surveyed, e.g. a cargo container or a transport vehicle, e.g. a money transporter.
